(19) United States
(12) Patent Application Publication
(10) Pub. No.: US 2008/0298772 A1
(43) Pub. Date: Dec. 4, 2008

(54) Interactive device

(75) Inventor: Toby King, Cremorne (AU)

Correspondence Address: WOOD, PHILLIPS, KATZ, CLARK & MORTIMER, 500 W. MADISON STREET, SUITE 3800, CHICAGO, IL, 60661, US

(73) Assignee: Sandra Bateman

(21) Appl. No.: 12/154,895

(22) Filed: May 28, 2008

(30) Foreign Application Priority Data
May 29, 2007 (AU) 2007902879

(51) Int. Cl. H04N 5/91

(52) U.S. Cl. 386/95; 386/E05.003

(57) ABSTRACT

This invention concerns an interactive data storage device and in particular the arrangement of information containing media items and menus stored on media or in servers. The data storage device contains interactive material comprising media items about particular goods or services together with plural menus. Each of the menus enables navigation through the media items according a particular point of view by allowing access only to media items that are relevant to that point of view.

### TECHNICAL FIELD

This invention concerns an interactive data storage device and in particular the arrangement of information and menus stored on the device.

### BACKGROUND ART

An entertainment DVD may contain a film plus a series of short related films, a video game and possibly other material such as advertising. In addition there may be written information such as a copyright warning or instructions and menus. The menu structure generally allows navigation through a tree to arrive at a particular item that can then be selected for viewing. When the DVD is played and a particular item is viewed there may be accompanying audio material such as a sound track, music or sound effects.

A DVD can also be used as a data storage medium for a computer. In this case the information on the DVD can be accessed using a computer in the same manner as any other computer storage media.

Interactive video discs are using for games. These contain programs that typically generate an artificial environment that can be navigated using special input devices. Various actions are allowable and these affect the navigation options, for instance opening and closing opportunities to move to places within the artificial environment.

In recent times marketing material has been put onto media including entertainment DVDs. Typically the material is in the form of a promotional video and it may be accompanied by additional material common to entertainment DVDs.

Consumers are overloaded with sales and marketing messages, and have become defensive, cynical and unreceptive to pure advertising. Product proliferation, decreasing brand loyalty, price sensitivity, less trust and message clutter is rife. TV advertising is becoming less powerful due to new technology and multiple channels, and an increasingly sophisticated and jaded public tuning out or fast forwarding through traditional 30 second TV commercials.

When consumers decide to acquire knowledge for themselves about a particular product or service they often do not know where to start. They may view a company's website, read magazines and newspaper articles, ask a peer group or they may contact the company either in person, via email or with a phone call. In any event the process is time-consuming and has no guarantee of success.

### DISCLOSURE OF THE INVENTION

The invention is a data storage device containing interactive material, wherein the interactive material includes media items about particular goods or services stored together with plural active menus. Each of the plural active menus enables navigation through the media items according a particular point of view by allowing access only to media items that are relevant to that point of view.

The device may be a server, such as a web server or data caster. It could also be a transmitter, or a receiving television or computer. The device may be portable, such as a DVD, MP3 player, iPod or cell phone.

The media items may include high quality video footage and surround sound to maximize the marketing and research experience to the consumer. It is intended to be viewed in the consumer's own home theater with family and friends, at work on a PC during breaks, or at play in mobile situations on laptops or portable DVD players.

The media items may serve two distinct purposes. First, they may serve a marketing purpose for the originator; typically a company that is promoting its goods and services. Second, they are intended to serve a research or educational purpose for the recipient (user) who is interested in finding out more about particular goods or services.

Overall the media items promote, inform, excite and motivate the customer to purchase, and at the same time is demographically targeted, honest and entertaining.

The media items may comprise information related to the activities of a particular business entity, such as a company or group of companies.

Use of the invention may replace the extensive research effort individuals usually undertake, substituting the myriad of information sources with a single product that is a definitive reference point for learning everything about, for instance, a company's products or services.

The media items may present:
text,
audio,
images,
video, or
a mixture of forms.

The media items may contain information related to the particular goods and services presented in the form of:
entertainment,
information,
news,
documentary,
competitions,
promotional material, or
a mixture of content.

The points of view may be defined according to the following items:
Default
   nationality,
   language.
Corporate
   originator,
   originator's brand,
   products
   services.
Demographic
   gender,
   age,
   race,
   background.
Reviews
   ‘Peer Life’ reviews,
   ‘Buyer’ reviews,
   ‘Technical’ reviews.

Special Features

Taken together the different points of view may provide flexibility in language, communication and content, allowing a tailoring of the message to facilitate pervasiveness and extend reach.

The inclusion of the ‘Reviews’ point of view make the medium a consumer focused sales tool.

The media items may provide a consistent, controlled, and informative message to consumers that encourages them to the end of their decision making process in the convenience of their homes.

The invention may provide a convenient product which can be watched on demand, and at a time that suits. This ensures the marketing message is conveyed when the viewer is motivated to listen and watch, maximizing the receptiveness of the consumer and optimizing the efficiency of the message.

The invention is ready to inform, educate and entertain any hour of the day, every day of the week, every week of the year. It may deliver the same consistent marketing message to consumers every time.

The device or material may have low duplication costs so that it can be distributed widely on a quarterly, biannual or annual basis depending on the requirement of the originator regarding the products and services lifecycle.

### BRIEF DESCRIPTION OF THE DRAWINGS

An example of the invention will now be described with reference to the accompanying drawings, in which:

FIG. 1 is an example menu structure.

FIG. 2 is a screenshot of an Internet TV page.

FIG. 3 is a screenshot of on demand TV.

### BEST MODES OF THE INVENTION

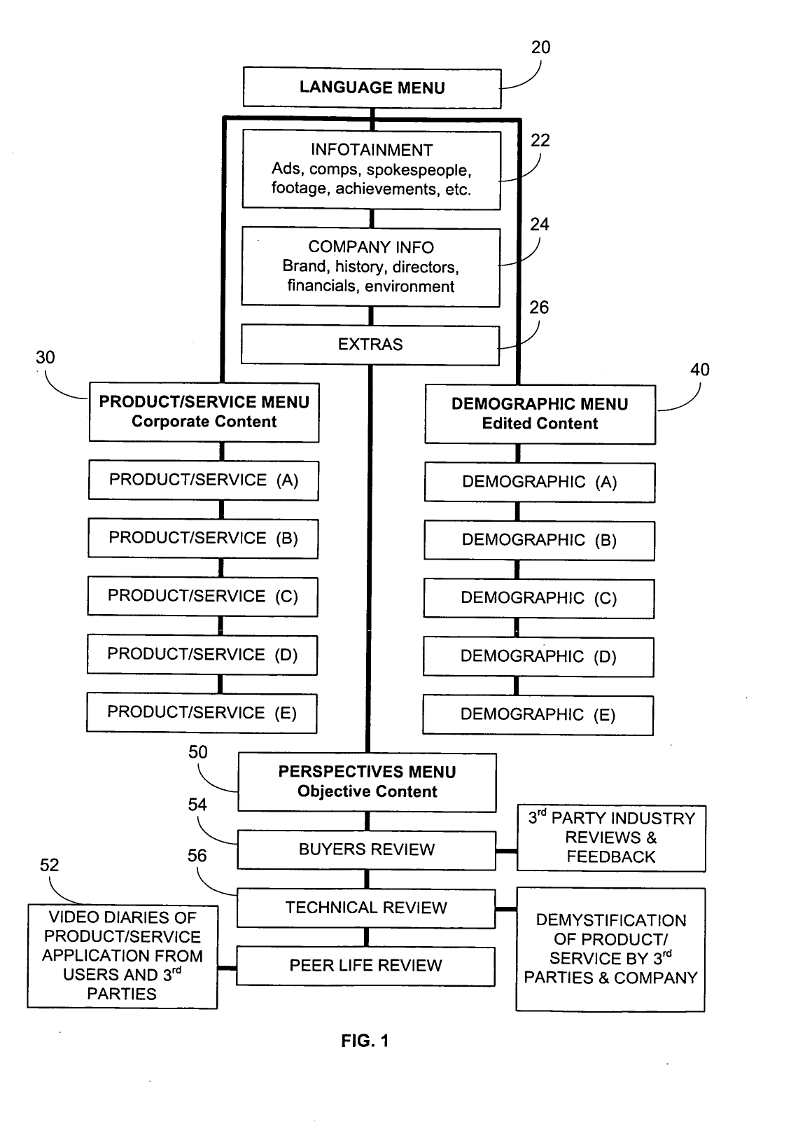

Referring first to FIG. 1, an interactive DVD is prepared on behalf of a company that supplies a range of goods and services. Information items are provided about the goods and services and a series of active menus 10 are also provided. The active menus may operate in any convenient fashion such as by using hyperlinks between items.

The DVD has the ability to contain hours of top quality video content and sound, company and brand information, product and service information, news, reviews, animations, documentaries, brochures, promotions, competitions and anything else relevant to the company and its brand, products and services.

The default menu that is seen upon automatic start-up provides a language menu 20 so the users can choose to view the DVD or read subtitles in their own language. This menu allows access to a variety of infotainment items 22 as well as company information 24 and extras 26.

After this initial language choice, users are provided with an interactive menu comprising three distinct points of view:

Selecting the first point of view presents a product or service driven menu 30 which provides choices among the range of products and services provided as well as details general information about the company and its brand. This is the corporate side of the menu and is for marketing and brand information relating to products or services.

Selecting the second point of view presents a consumer oriented menu 40 comprising demographic selections. Each demographic selection leads to a further menu that presents a list of items targeted to that demographic. The menus allow click-through to presentations that are aligned to the selected gender, race and of similar age and background where possible. In doing so, the items become a non-threatening and believable source of information during the presentation to that particular demographic audience. This menu has the flexibility to provide the best-fit possible for the company to make their marketing message as user friendly and tailored as possible to these groups.

For example, a menu comprising social demographics may comprise the options of a single male, single female, couples, families, B2B, retirees and children. Alternatively, the menu may comprise age brackets and gender for different applications.

An alternative menu based on economic demographics may comprise individual or household income brackets, and in the case of retirees, whether they are self-funded.

Another menu option is to have grouping by profession, such as professional, trade, business owner etc.

After individuals select the option which represents them, they are provided with a submenu choice of products or services that a relevant to their particular demographic. All marketing information provided is specifically tailored to the needs, requirements and interests of this individual.

Selecting the third point of view presents a “perspectives” menu 50 that comprises objective video diary reviews by users and industry experts of the company's products or services 52. These reviews provide consumers with a unique research tool and comprise ‘Peer Life’ reviews, ‘Buyer’ reviews 54, and where relevant ‘Technical’ reviews 56. The reviews are presented in a documentary presentation style that is entertaining, informative, objective, honest, exciting, professional and insightful.

The ‘Buyers’ review 54 provides users with a presentation detailing comprehensive information on the company's products or services. The review may be presented by third party industry experts, well known trusted source ‘personalities’, or company experts—such as executives or senior brand managers. The products or services can be reviewed against alternatives within the company and the products or services of competitors. This gives consumers the knowledge they desire, and a point of reference for comparison.

The ‘Technical’ review 56 showcases the technical and engineering aspects of a company's product range, presented as documentaries by the company's technical staff and guest presenters.

The ‘Peer Life’ review 52 centres around real people providing objective real-life feedback on the company's products or services through video diaries. The ‘Peer Life’ review may consist of company's placing their products in the real world, with various peer groups which are aligned with the pertinent demographic groups. Alternatively, the review may centre around peer groups that have been using the company's services in the real world for some time.

A special features menu may provide additional infotainment documentary footage on the company and its products or services. The content is totally flexible and scalable and can contain whatever the company's deem worthy for inclusion. The special features menu allows consumers to view information and entertainment above and beyond the information provided specifically on the company's products or services. Consumers can experience the company's history, special moments in the products or services lifecycle, development, the company's personalities, corporate advertisements, design directions, technical developments, competitions and promotions.

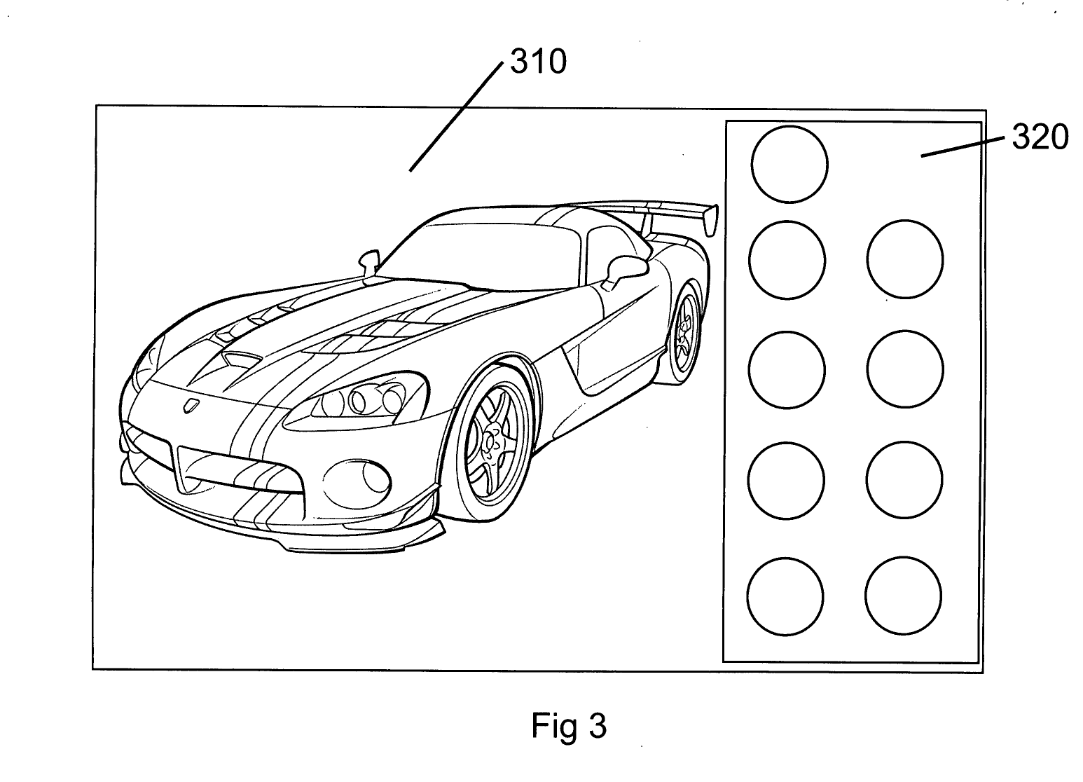

It will be appreciated that this functionality can be delivered by alternative media besides DVD. For instance, an Internet TV may provide the same functionality. In this case, with reference to FIG. 2, the computer screen will display the homepage 210 for the interactive material together with a menu 220. It can be seen that this menu provides language, age and gender choices.

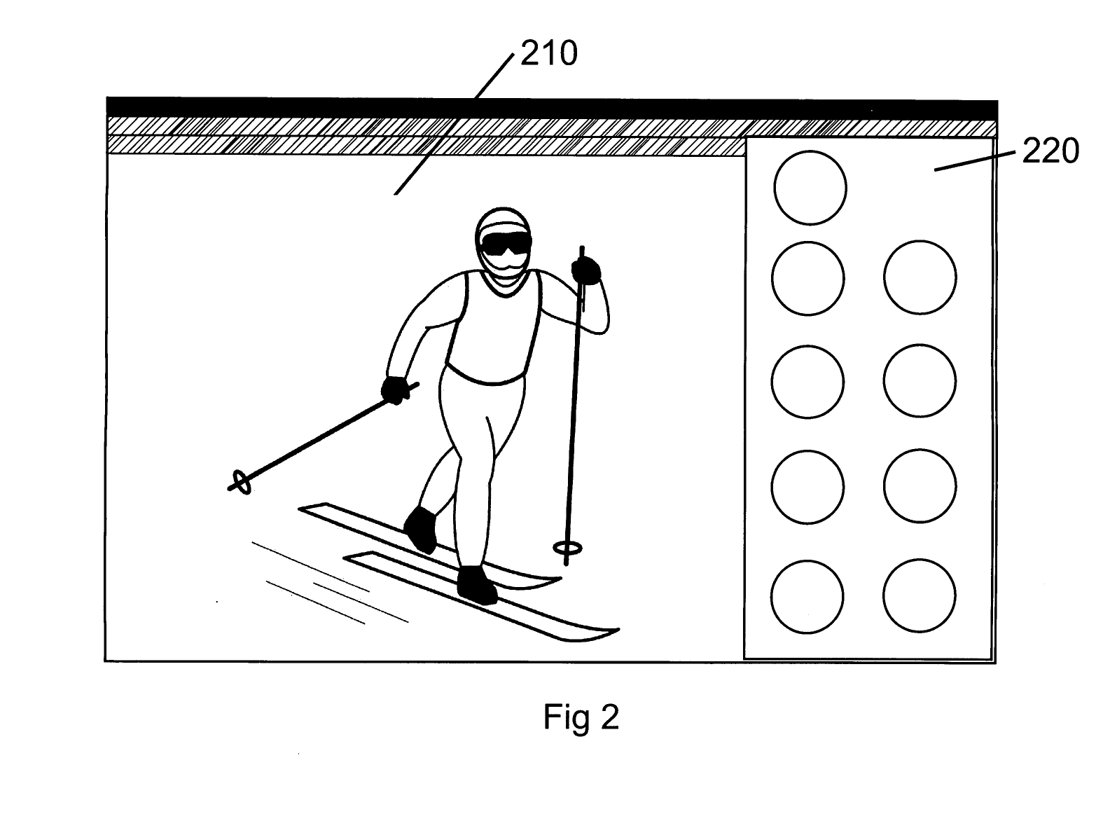

In another alternative, digital on demand TV can also provide the same functionality for the interactive material, see FIG. 3. In this example the TV screen presents the content 310 together with menu 320 which also provides language, age and gender choices for the user.

In both these cases the users will see content and advertising that is accurately directed to their age and gender grouping. They will also be able to navigate from this starting point into progressively more specifically identified content available through the medium of their choice. In corollary the operators of the medium are able to produce and display content, films and advertising for products and services matched to the target demographics, and the user is able to opt in or out.

The “options” button gives access to further personal dashboard information by which the user can refine their profile. This facility can also be used to apply censorship locks and other chosen restrictions on the content. The facility may also be used to provide religious filtering, either to restrict display of potentially offensive material or to include relevant religious material.

A number of example menus will now be presented for different originators:

### AUTOMOTIVE INDUSTRY

### Language Menu

### About the Company

### Infotainment

### Product Menu

### Cars

### FWD'S/SUV's

### People Carriers

### Utilities

### Demographic Menu

### Single Female

### Couples

### Families

### Business Owners

### Perspectives Menu

### Buyer Review

### Technical Review

### Peer Life Review

### BANKING INDUSTRY

### Language Menu

### About the Company

### Contacts

### Awards

### History

### Product/Services Menu

### Online

### Personal

### Commercial

### Corporate

### Personal Banking

### Stock Broking

### Financial Planning

### Insurance

### Credit Cards

### Savings & Transactions accounts

### Home Loans

### Car Loans

### Personal Loans

### Margin Lending

### Small Business

### Commercial Banking

### Transactional Banking

### Financial & Borrowing

### International Trade

### Treasury & Capital Markets

### Corporate Banking

### Relationship Partners

### Treasury & Capital Markets

### Financial Services

### Global Payment & Cash Management

### International Trade

### Investment Banking

### Demographic Menu

### Individual—Single

### Individual—Family

### Individual—Retiree

### Business Owner

### Corporate Employee

### Perspectives Menu

### Product Review

### Peer Life Review

### HEALTH INSURANCE

### Language Menu

### Geography Menu

### About the Company

### Health

### Life Insurance

### Travel

### Retirement Solutions

### Product Menu

### Health Cover

### Corporate Plans

### Emergency Ambulance

### Life Insurance

### Travel Insurance

### Financial Advice

### Health Assistance

### Services Menu

### Member Benefits

### Health Assistance

### Demographic Menu

### Single

### Couple

### Family

### Employer

### Age Group: 18-29

### Age Group: 30-49

### Age Group: 50-64

### Age Group: 65-69

### Perspectives Menu

### Buyer Review

### Peer Life Review

### REAL ESTATE

### Language Menu

### About the Company

### Location Guide/Find an Agent

### Market Monitor

### Guides

### Product/Services Menu

### Selling

### Renting

### Commercial

### Finance

### Demographic Menu

### Owner—Occupier

### Owner—Investor

### Perspectives Menu

### Buyer/Seller/Investor Review

### Peer Life Review

### CONSTRUCTION/DEVELOPMENT INDUSTRY

### Language Menu

### About the Company

### Investor Information

### Product/Services Menu

### Real Estate for Sale

### Real Estate for Lease

### Hotels/Property

### Funds Management

### Demographic Menu

### Owner—Investor

### Investor

### Perspectives Menu

### Product Review

### Peer Life Review

### AGED HEALTHCARE

### Language Menu

### Geographic Menu

### About the Industry

### News/Events/Conferences

### Product/Services Menu

### Aged Care Facilities

### Retirement Villages

### Community Care

### Careconnect (Vic)

### Bluecare (Qld)

### Community Vision (WA)

### Professional Services

### Aged Care Consultancy

### Building & Design

### Legal

### Health

### Demographic Menu

### Do You Want Information for Yourself—

### Do You Want Information for a Family Member

### Perspectives Menu

### Product Review

### Peer Life Review

### AIRLINES/TOURISM

### Language Menu

### Geographic Menu

### About the Company

### News & Promotions

### Destinations & Holidays

### Product/Services Menu

### Destinations

### Places of Interest/Planning

### Destination Tourism Information

### Local Destination Contacts & Info

### (All International Airlines)

### (All International Tourism Bureaus)

### Professional Services

### Passenger Care

### Aircraft & Design

### Legal & Track Record

### Health

### Administrative & Rewards

### Demographic Menu

### Single

### Family

### Business

### Language

### Perspectives Menu

### Product Review

### Peer Life Review

The objective of invention is to provide consumers with an interactive, user-friendly product which is ‘The’ reference point for the objective transfer of knowledge about a company's products or services. This is not just a promotional DVD product it is a strategic sales tool delivered currently on the DVD platform.

The concept has the opportunity to work alongside other media such as digital television, data casting on demand, interactive television and Web TV.

The DVD's may also have a release cycle with the product or service required, eg summer, spring, fall, winter collections etc.

Although the invention has been described with reference to a particular example, it should be appreciated that it could be exemplified in many other forms and in combination with other features not mentioned above.

1. An interactive data storage device containing interactive material, wherein the interactive material includes media items about particular goods or services stored together with plural active menus; and wherein, each of the plural active menus enables navigation through the media items according a particular point of view by allowing access only to media items that are relevant to that point of view.

2. An interactive data storage device according to claim 1, wherein the device is a server.

3. An interactive data storage device according to claim 2, wherein the device is a web server

4. An interactive data storage device according to claim 1, wherein the device is a data caster.

5. An interactive data storage device according to claim 1, wherein the device is a display device.

6. An interactive data storage device according to claim 1, wherein the device is portable.

7. An interactive data storage device according to claim 6, wherein the device is a portable display device.

8. An interactive data storage device according to claim 6, wherein the device is a DVD.

9. An interactive data storage device according claim 1, wherein the storage media comprises information related to the activities of a particular business entity.

10. An interactive data storage device according to claim 1, wherein the media items present:
text,
audio,
images,
video, or
a mixture of forms.

11. An interactive data storage device according to claim 1, wherein the media items contain information related to the particular goods and services presented in the form of:
entertainment,
information,
news,
documentary,
competitions,
promotional material, or
a mixture of content.

12. An interactive data storage device according to claim 1, wherein the points of view are defined according to the following items:
Default
nationality,
language;
Corporate
originator,
originator's brand,
products,
services;
Demographic
gender,
age,
race,
background;
Reviews
‘Peer Life’ reviews,
‘Buyer’ reviews,
‘Technical’ reviews;
Special Features.
